(19) United States
(12) Patent Application Publication
(10) Pub. No.: US 2016/0156523 A1
(43) Pub. Date: Jun. 2, 2016

(54) Method and System for Network Topology

(71) Applicant: ZTE CORPORATION, Shenzhen City, Guangdong Province (CN)

(72) Inventors: Chun LUO, Shenzhen (CN); Zhihong WANG, Shenzhen (CN)

(21) Appl. No.: 14/904,106

(22) PCT Filed: May 20, 2014
(86) PCT No.: PCT/CN2014/077858

§ 371 Date: Jan. 11, 2016

(30) Foreign Application Priority Data
Jul. 15, 2013 (CN) 201310296782.3

(51) Int. Cl. H04L 12/24; H04L 12/723; H04L 12/721

(52) U.S. Cl. CPC H04L 41/12; H04L 41/0853; H04L 45/12; H04L 45/50

(57) ABSTRACT

Disclosed are a method and system for network topology, wherein the method includes: dividing label switching routers in a single control area into a plurality of sub-areas, the label switching routers in each sub-area forming Open Shortest Path First neighbors; acquiring traffic engineering resource information of each sub-area, collecting the traffic engineering resource information of all the sub-areas, and generating a network topology within the single control area.

### TECHNICAL FIELD

The present document relates to the field of communication technologies, and more particularly, to a method and system for network topology.

### BACKGROUND OF THE INVENTION

The MPLS-TE (Multi-Protocol Label Switching-Traffic Engineer) combines the advantages of multi-protocol label switching technology and traffic engineering technology, and achieves dynamic adjustment and optimal allocation of network bandwidth resources in the packet switching and the 2-Layer switching, the GMPLS (Generalized Multi-Protocol Label Switching) is a further extension of the MPLS-TE, and it can not only support the IP (Internet Protocol) packet switching, but also support slot switching, wavelength switching and space switching (such as optical fiber switching and interface switching).

The traffic engineer resource information is flooded to all label switching routers (called LSR) in the control area through a routing protocol, and each LSR can form the entire network topology within the control area, compute a path according to service establishment requirements and establish a service through a signaling protocol.

The routing protocol and the signaling protocol run on a data communications network (referred to as DCN), and corresponding services run in a data plane or a transfer plane. In the MPLS-TE network, the DCN generally uses the in-band way to remain the same topology as the data plane, and in the GMPLS network, the DCN generally uses the out-of-band way and is independent of the data plane.

The expansion of network scale of a single control area is mainly limited by the path computation power and the resource flooding convergence speed. For the path computation capability, this limit can be broken through by introducing the path computation element (called PCE) as a single functional entity, but since the resource flooding is the network-wide flooding within a single control area, when there are a lot of network resources, the convergence speed will be affected, and currently there are no related means to improve it.

In the IP routing network, a standard OSPF (Open Shortest Path First) protocol is used to exchange the routing information in the control area, when the network scale is expanded, the Area (refer to the section area consisting of control interfaces in the OSPF) division way is often used to solve the problem of slow flooding convergence. In the MPLS-TE or the GMPLS network, the routing flooding protocol generally uses the OSPF-TE (Open Shortest Path First-Traffic Engineer) protocol, and an interface for each LSR running the OSPF-TE protocol is called a control interface, the traffic engineer resource information is flooded to other LSRs through the control interface, in accordance with the OSPF-TE specification, the opaque LSA (Link State Advertisements, referred LSA) whose type is 10 is used to flood, the flooding range is limited to be within one OSPF Area, and it cannot be flooded to the entire autonomous area, therefore a control field generally only has one OSPF Area, and the OSPF Area id is 0, there is no method to solve the problem of slow flooding convergence with the area division way.

Because the scale of a single control area is limited, when the number of LSRs in a single control area increases to a certain extent, the general practice in the industry is to split the control area, and use the ENNI (External Network-Network Interface) link to connect the control areas. Because the resource information is isolated among the control areas, the flooded resource information between the areas is only some abstract content, while functions of services within some single control areas are difficult to be implemented in cross-area services.

### SUMMARY

The present document provides a method and system for network topology to accelerate a resource flooding convergence speed.

The present document provides a method for network topology, comprising:

dividing label switching routers in a single control area into a plurality of sub-areas, and the label switching routers within each sub-area forming Open Shortest Path First neighbors; and

acquiring traffic engineer resource information of each of the sub-areas, collecting the traffic engineering resource information of all the sub-areas, and generating a network topology within the single control area.

Alternatively, the abovementioned method may further have the following feature: acquiring traffic engineering resource information of each of the sub-areas, collecting the traffic engineering resource information of all the sub-areas, and generating a network topology within the single control area, comprises:

a path computation element acquiring traffic engineer resource information of each of the sub-areas, collecting the traffic engineering resource information of all the sub-areas, and generating a network topology within the single control area.

Alternatively, the abovementioned method further has the following feature:

said dividing label switching routers in a single control area into a plurality of sub-areas, and the label switching routers within each sub-area forming Open Shortest Path First neighbors, comprises:

dividing label switching routers within the single control area into a plurality of Open Shortest Path First areas, and assigning a separate Open Shortest Path First area identifier greater than zero to each Open Shortest Path First area, and configuring the Open Shortest Path First area identifier onto a control interface of corresponding label switching routers.

Alternatively, the abovementioned method may have the following feature: before the path computation element acquires the traffic engineering resource information of each of the sub-areas, the method further comprises:

in the path computation element, configuring a control interface for each divided Open Shortest Path First area, configuring a corresponding Open Shortest Path First area identifier for each control interface, making the control interface and label switching routers in a corresponding Open Shortest Path First area become neighbors.

Alternatively, the abovementioned method further has the following feature:

said dividing the label switching routers in a single control area into a plurality of sub-areas, and the label switching routers within each sub-area forming Open Shortest Path First neighbors, comprises:

dividing label switching routers in a single control area into a plurality of sub-areas, and the label switching routers within each sub-area forming Open Shortest Path First neighbors; and

before the path computation element acquires the traffic engineer resource information of each of the sub-areas, further comprising:

initiating an Open Shortest Path First protocol processing instance for each divided sub-area in the path computation element, and each Open Shortest Path First protocol processing instance configuring a control interface to become neighbors with the label switching routers in a corresponding sub-area.

The present document further provides a system for network topology, comprising:

a first module, configured to divide label switching routers in a single control area into a plurality of sub-areas, wherein the label switching routers within each sub-area form Open Shortest Path First neighbors; and

a second module, configured to, acquire traffic engineer resource information of each of the sub-areas, collect the traffic engineering resource information in all sub-areas, and generate a network topology within the single control area.

Alternatively, the abovementioned system may further have the following feature:

the first module is configured to divide label switching routers within a single control area into a plurality of Open Shortest Path First areas, and assign a separate Open Shortest Path First area identifier greater than zero to each Open Shortest Path First area, and configure the Open Shortest Path First area identifier onto a control interface of corresponding label switching routers.

Alternatively, the abovementioned system may have the following feature:

the second module is further configured to: configure a control interface for each divided Open Shortest Path First area, configure a corresponding Open Shortest Path First area identifier for each control interface, make the control interface and the label switching routers in a corresponding Open Shortest Path First area become neighbors.

Alternatively, the abovementioned system further has the following feature:

the first module is configured to divide label switching routers in a single control area into a plurality of sub-areas, wherein the label switching routers within each sub-area form Open Shortest Path First neighbors, and

the second module is further configured to initiate an Open Shortest Path First protocol processing instance for each divided sub-area the second module, wherein each Open Shortest Path First protocol processing instance configures a control interface to become neighbors with the label switching routers in a corresponding sub-area.

In summary, the embodiment of the present document provides a method and system for network topology, to accelerate a resource flooding convergence speed, break through the limit of network scale of a single control area, and ensure various functions of the user service.

### BRIEF DESCRIPTION OF THE DRAWINGS

FIG. 1 is a flow chart of a method for network topology in accordance with an embodiment of the present document;

FIG. 2 is a networking diagram of a network topology in accordance with a first embodiment of the present document;

FIG. 3 is a networking diagram of a network topology in accordance with a second embodiment of the present document;

FIG. 4 is a schematic diagram of a system for network topology in accordance with an embodiment of the present document.

### PREFERRED EMBODIMENTS OF THE INVENTION

Hereinafter in conjunction with the accompanying drawings, the embodiments of the present document will be described in detail. It should be noted that in the case of no conflict, embodiments and features in the embodiments of the present application may be arbitrarily combined with each other.

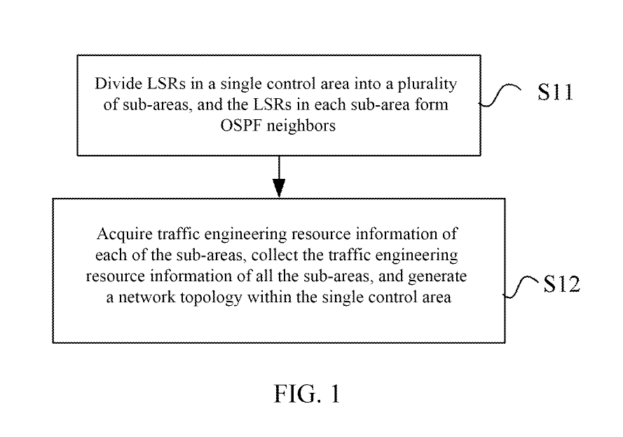

FIG. 1 is a flow chart of a method for network topology in accordance with an embodiment of the present document, comprising the following steps:

in step S11, it is to divide LSRs in a single control area into a plurality of sub-areas, and the LSRs in each sub-area form OSPF neighbors;

in step S12, it is to acquire traffic engineering resource information of each of the sub-areas, collect the traffic engineering resource information of all the sub-areas, and generate a network topology within the single control area.

In the method according to the present embodiment, it is to divide a single control area into a plurality of sub-areas, wherein each LSR belongs to only one sub-area, the flooding information is limited in the sub-area, the way of introducing the PCE in the entire control area is used, it is to acquire resource information of all sub-areas through the PCE, limit the information amount of resource flooding, increase the flooding convergence speed, while various operations of the service are executed still in accordance with the situation of a single control area, and various and flexible operating functions in the single control area are provided to the user service.

### The First Embodiment

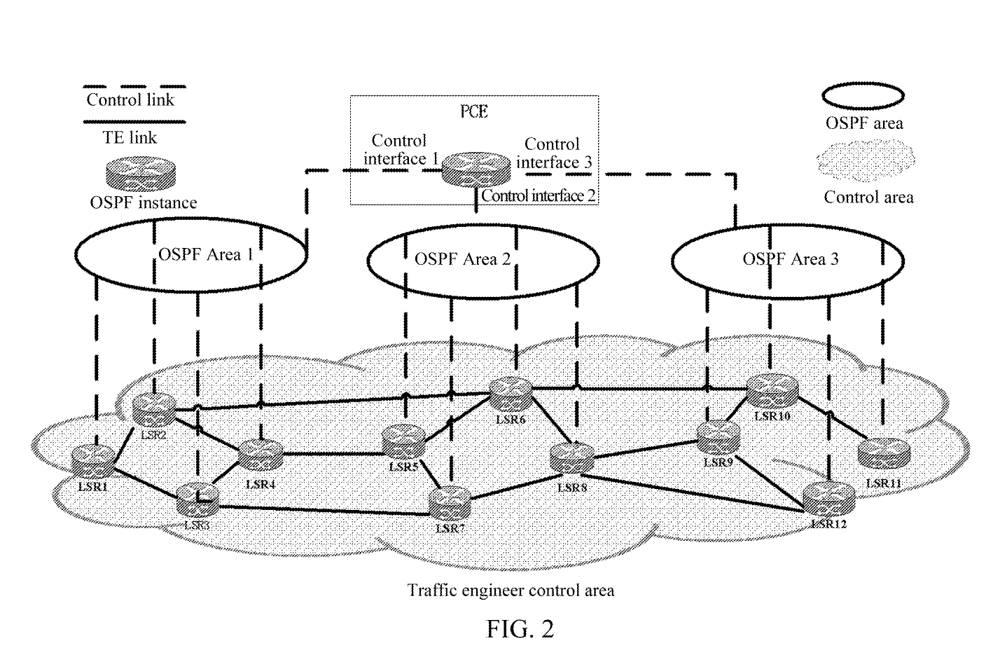

In the following, the embodiment of the present document will be described in conjunction with FIG. 2, and the traffic engineering resource information of all LSRs has been previously configured, comprising the following steps:

in step 101, it is to divide the LSRs in the control area into different OSPF Areas, a separate OSPF Area id greater than 0 is assigned to each area, and the OSPF Area id is configured onto the LSR's control interface.

According to the OSPF-TE flooding specification, only the LSRs within the same OSPF Area can form neighbors, the traffic engineer resource information of the LSR is flooded through the Opaque LSA whose type is 10, and only flooded to the control interface of other LSRs forming neighbors, that is, it can only be flooded within each sub-area, but cannot be flooded to other OSPF areas.

As shown in FIG. 2, the control interface of LSR1, LSR2, LSR3, LSR4 is configured to the OSPF Area1, the control interface of LSR5, LSR6, LSR7, LSR8 is configured to OSPF Area2, and the control interface of LSR9, LSR10, LSR11, LSR12 is configured to OSPF Area3.

In step 102, it is to introduce the PCE in the entire control area, and configure a control interface for each divided OSPF Area in the PCE, configure a corresponding OSPF Area id for each control interface, make the control interface in the PCE and the LSRs in the corresponding OSPF Area become neighbors. Therefore, the PCE can acquire the traffic engineer resource information of the corresponding OSPF Area through different control interfaces.

As shown in FIG. 2, three control interfaces are configured on the PCE, the OSPF Area id of the control interface 1 is 1, the OSPF Area id of the control interface 2 is 2, and the OSPF Area id of the control interface 3 is 3. The control Interface 1 and the LSRs in the OSPF Areal are OSPF neighbors, the control Interface 2 and the LSRs in the OSPF Area2 are OSPF neighbors, and the control Interface 3 and the LSRs in the OSPF Area3 are OSPF neighbors.

In step 103, the PCE collects the traffic engineer resource information acquired by all the control interfaces, generates the network topology within a single control area, and forms the entire network topology of the entire control area.

After the abovementioned configuration completes, through the traffic engineer resource information flooding, the PCE collects the resource information of the OSPF Area1 from the Control Interface 1, the resource information of the OSPF Area2 from the control interface 2, and the resource information of the OSPF Area3 from the control interface 3, and collects all the resource information to constitute a traffic engineer database in the control area and form the entire network topology.

In step 104, when executing a traffic engineer path computation within the control area, if the path can be determined in the LSR, then it is to determine whether to request the PCE for a path based on the appropriate policy; if the path cannot be determined in the LSR, it is to directly request the PCE for a path.

If it needs to establish a service from LSR1 to LSR4, it is to initiate a path computation request in the LSR1, because the LSR1 can acquire resource information of the LSR4, the LSR1 can compute a path from the resource database of the local node based on the policy, and execute the service establishment, or it can send a path computation request to the PCE, and the PCE computes and returns a path to execute the service establishment.

If it needs to establish a service from the LSR1 to the LSR11, since the LSR1 cannot acquire resource information of the LSR11, it sends a path computation request to the PCE, and the PCE can compute a path to the LSR11 through the entire network topology information and return it to the LSR1 to execute the service establishment.

### The Second Embodiment

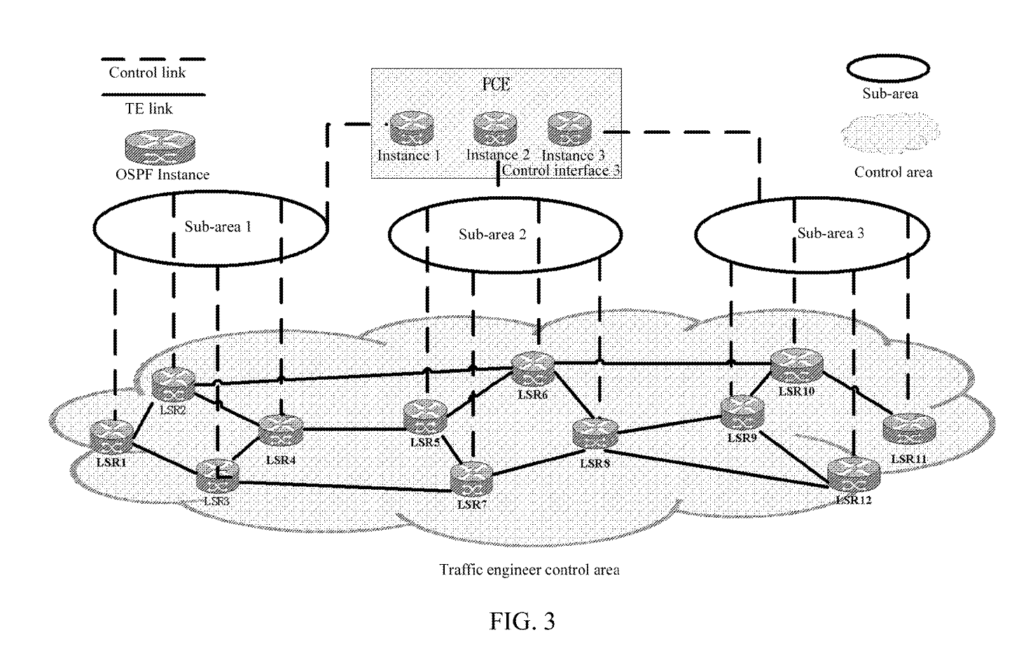

In the following, the embodiment of the present document will be described in conjunction with FIG. 3. The traffic engineering resource information of all the LSRs has been previously configured, and the following steps are started:

in step 201, it is to divide the LSRs in the control area into different sub-areas, the LSRs within each sub-region form OSPF neighbors, while the LSRs in different sub-areas cannot form OSPF neighbors.

As shown in FIG. 3, the control interface of LSR1, LSR2, LSR3, LSR4 belongs to the sub-area1, the control interface of LSR5, LSR6, LSR7, LSR8 belongs to the sub-area2, and the control interface of LSR9, LSR10, LSR11, LSR12 belongs to the sub-area3. The neighbors are formed according to the DCN network situation, and the LSRs in each sub-area can be configured as neighbors, while the LSRs in different sub-areas cannot be configured as neighbors.

In step 202, it is to introduce the PCE in the entire control area, and initiate one OSPF protocol processing instance for each sub-area in the PCE, and each OSPF instance configures one control interface to become neighbors with the LSRs in the corresponding sub-area, so that the PCE can acquire the traffic engineer resource information of the corresponding sub-area through different OSPF instances.

As shown in FIG. 3, three OSPF instances are initiated on the PCE, the instance 1 corresponds to the sub-area 1 to become neighbors with the LSRs in the sub-area 1; the instance 2 corresponds to the sub-area 2 to become neighbors with the LSRs in the sub-area 2; the instance 3 corresponds to the sub-area 3 to become neighbors with the LSRs in the sub-area 3.

In step 203, various OSPF instances in the PCE share the traffic engineer database, collect the traffic engineer resource information acquired by all the sub-areas, and generate the network topology within the single control area, and form the entire network topology of the entire control area.

After the abovementioned configuration completes, through the traffic engineer resource information flooding, the PCE collects the resource information of the sub-areal from the instance 1, the resource information of the sub-area2 from the instance 2, and the resource information of the sub-area3 from the instance 3, collects all the resource information to constitute a traffic engineer database in the control area and form the entire network topology.

in step 204, when executing a traffic engineer path computation within the control area, if the path can be determined in the LSR, it is to determine whether to request the PCE for a path based on the appropriate policy; if the path cannot be determined in the LSR, it is to directly request the PCE for the path.

If it needs to establish a service from LSR1 to LSR4, it is to initiate a path computation request in the LSR1, because the LSR1 can acquire resource information of the LSR4, the LSR1 can compute a path from the resource database of the local node based on the policy and execute the service establishment, or it can send a path computation request to the PCE, the PCE computes and returns a path to execute the service establishment.

If it needs to establish a service from the LSR1 to the LSR11, since the LSR1 cannot acquire resource information of the LSR11, it sends a path computation request to the PCE, and the PCE can compute a path to the LSR11 through the entire network topology information, and return it to the LSR1 to execute the service establishment.

The method of the present embodiment divides a single control area into sub-areas, limits the traffic engineer resource information flooding scope into the sub-area, introduces the PCE, acquires resource information of all the sub-areas through the PCE, and collects the information to form the entire network topology of a single control area.

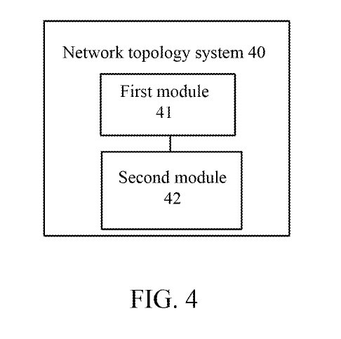

FIG. 4 is a schematic diagram of network topology system 40 in accordance with the embodiment of the present document, as shown in FIG. 4, the system of the present embodiment comprises:

A first module 41, configured to divide label switching routers in a single control area into a plurality of sub-areas, wherein the label switching routers within each sub-area form Open Shortest Path First neighbors; and

A second module 42, configured to, acquire traffic engineer resource information of each of the sub-areas, collect the traffic engineer resource information of all the sub-areas, and generate a network topology in the single control area.

In a preferred embodiment, the second module is a path computation element.

In a preferred embodiment, the first module is configured to divide the label switching routers within a single control area into a plurality of Open Shortest Path First areas, and assign a separate Open Shortest Path First area identifier greater than zero to each Open Shortest Path First area, and configure the Open Shortest Path First area identifier onto a control interface of the corresponding label switching routers.

The path computation element is further configured to, configure one control interface for each divided Open Shortest Path First area, configure a corresponding Open Shortest Path First area identifier for each control interface, and make the control interface and the label switching routers in the corresponding Open Shortest Path First area become neighbors.

In a preferred embodiment, the first module is configured to divide the label switching routers in a single control area into a plurality of sub-areas, wherein the label switching routers in each sub-area form Open Shortest Path First neighbors;

the path computation element is further configured to initiate an Open Shortest Path First protocol processing instance for each divided sub-area in the path computation element, wherein each Open Shortest Path First protocol processing instance configures a control interface to become neighbors with label switching routers in the corresponding sub-area.

Those ordinarily skilled in the art can understand that all or some of steps of the abovementioned method may be completed by the programs instructing the relevant hardware, and the programs may be stored in a computer-readable storage medium, such as read only memory, magnetic or optical disk. Alternatively, all or some of the steps of the abovementioned embodiments may also be implemented by using one or more integrated circuits. Accordingly, each module/unit in the abovementioned embodiments may be realized in a form of hardware, or in a form of software function modules. The present document is not limited to any specific form of hardware and software combinations.

The above description is only preferred embodiments of the present document, and of course, the present document may also have other various embodiments, without departing from the spirit and essence of the present document, a person skilled in the art may make various appropriate changes and modifications according to the present document, and these appropriate changes and modifications should be included within the protection scope of the appended claims of the present document.

### INDUSTRIAL APPLICABILITY

The embodiment of the present document provides a method and system for network topology, to accelerate a resource flooding convergence speed, break through the limit of network scale of a single control area, and ensure various functions of the user service.

What is claimed is:

1. A method for network topology, comprising:
dividing label switching routers in a single control area into a plurality of sub-areas, and the label switching routers within each sub-area forming Open Shortest Path First neighbors; and
acquiring traffic engineer resource information of each of the sub-areas, collecting the traffic engineering resource information of all the sub-areas, and generating a network topology within the single control area.

2. The method of claim 1, wherein, acquiring traffic engineering resource information of each of the sub-areas, collecting the traffic engineering resource information of all the sub-areas, and generating a network topology within the single control area, comprises:
a path computation element acquiring traffic engineer resource information of each of the sub-areas, collecting the traffic engineering resource information of all the sub-areas, and generating a network topology within the single control area.

3. The method of claim 2, wherein:
said dividing label switching routers in a single control area into a plurality of sub-areas, and the label switching routers within each sub-area forming Open Shortest Path First neighbors, comprises:
dividing label switching routers within the single control area into a plurality of Open Shortest Path First areas, and assigning a separate Open Shortest Path First area identifier greater than zero to each Open Shortest Path First area, and configuring the Open Shortest Path First area identifier onto a control interface of corresponding label switching routers.

4. The method of claim 3, wherein, before the path computation element acquires the traffic engineering resource information of each of the sub-areas, the method further comprises:
in the path computation element, configuring a control interface for each divided Open Shortest Path First area, configuring a corresponding Open Shortest Path First area identifier for each control interface, making the control interface and label switching routers in a corresponding Open Shortest Path First area become neighbors.

5. The method of claim 2, wherein,
said dividing label switching routers in a single control area into a plurality of sub-areas, and the label switching routers within each sub-area forming Open Shortest Path First neighbors, comprises:
dividing label switching routers in a single control area into a plurality of sub-areas, and the label switching routers within each sub-area forming Open Shortest Path First neighbors; and
before the path computation element acquires the traffic engineer resource information of each of the sub-areas, further comprising:
initiating an Open Shortest Path First protocol processing instance for each divided sub-area in the path computation element, and each Open Shortest Path First protocol processing instance configuring a control interface to become neighbors with the label switching routers in a corresponding sub-area.

6. A system for network topology, comprising:
a first module, configured to divide label switching routers in a single control area into a plurality of sub-areas, wherein the label switching routers within each sub-area form Open Shortest Path First neighbors; and
a second module, configured to, acquire traffic engineer resource information of each of the sub-areas, collect the traffic engineering resource information in all sub-areas, and generate a network topology within the single control area.

7. The system of claim 6, wherein:
the first module is configured to divide label switching routers within a single control area into a plurality of Open Shortest Path First areas, and assign a separate Open Shortest Path First area identifier greater than zero to each Open Shortest Path First area, and configure the Open Shortest Path First area identifier onto a control interface of corresponding label switching routers.

8. The system of claim 7, wherein:
the second module is further configured to: configure a control interface for each divided Open Shortest Path First area, configure a corresponding Open Shortest Path First area identifier for each control interface, make the control interface and the label switching routers in a corresponding Open Shortest Path First area become neighbors.

9. The system of claim 6, wherein:
the first module is configured to divide label switching routers in a single control area into a plurality of sub-areas, wherein the label switching routers within each sub-area form Open Shortest Path First neighbors; and
the second module is further configured to initiate an Open Shortest Path First protocol processing instance for each divided sub-area in the second module, and wherein each Open Shortest Path First protocol processing instance configures a control interface to become neighbors with the label switching routers in a corresponding sub-area.
